(19) United States
(12) Patent Application Publication
(10) Pub. No.: US 2010/0138345 A1
(43) Pub. Date: Jun. 3, 2010

(54) FINANCIAL TRANSACTION SYSTEM HAVING LOCATION BASED FRAUD PROTECTION

(76) Inventors: Leon Lekhtman, Montreal (CA); Robert J. Graham, Toronto (CA)

Correspondence Address: Douglas B Teaney;Greenberg Traurig, 77 W Wacker Drive, Suite 3100, Chicago, IL, 60601, US

(21) Appl. No.: 12/452,656

(22) PCT Filed: Jul. 11, 2008
(86) PCT No.: PCT/CA2008/001269

§ 371 Date: Jan. 13, 2010

Related U.S. Application Data
(60) Provisional application No. 60/949,594, filed on Jul. 13, 2007.

(51) Int. Cl. G06Q 20/00; G01C 21/00; G06Q 40/00

(52) U.S. Cl. 705/44; 701/300; 701/213

(57) ABSTRACT

A financial transaction authorization server comprises a database of records of fixed-location transaction participants, and transaction authorization means in communication with the database of records. Each record of the database of records is associated with a respective one of the fixed-location transaction participants and identifies a physical location of the associated fixed-location transaction participant. The transaction authorization means is configured to (i) receive a request from one of the fixed-location transaction participants for completion of a financial transaction; (ii) receive current location information of a mobile-location transaction participant associated with the financial transaction; and (iii) authorize the transaction in accordance with a correlation between the received current location information and physical location of the fixed-location transaction participant.

### RELATED APPLICATIONS

This application claims the benefit of the filing date of U.S. Provisional Patent Application No. 60/949,594 filed on Jul. 13, 2007 entitled Financial Transaction System Having Location-Based Fraud-Protection.

### FIELD OF THE INVENTION

The invention described herein relates to a system for reducing the likelihood of occurrence of fraudulent financial transactions.

### BACKGROUND OF THE INVENTION

Kramer (U.S. Pat. No. 6,934,849) teaches a method for authorizing a commercial transaction that begins with the service provider establishing a telephone link with an authorization provider. If the telephone link has been previously authorized, the service provider accepts the link, and then requests the customer to provide an identifier and a biometric sample over the link. The authorization provider authorizes the transaction if the correspondence between the biometric sample and a stored biometric exceeds a threshold value.

Williams (U.S. Pat. No. 7,152,788) teaches a method for managing the risk of a commercial transaction that involves transmitting the location co-ordinates of the vendor to an authorization host, calculating the risk of the transaction from, in part, the location co-ordinates, and then accepting or denying the commercial transaction at the authorization host based on the calculated risk.

### SUMMARY OF THE INVENTION

The invention makes use of current location information of a mobile participant in a financial transaction for the purpose of authorizing the financial transaction.

According to one aspect of the invention, there is provided a method of limiting the likelihood of occurrence of a fraudulent financial transaction. The method involves receiving a request from a first transaction participant for completion of a financial transaction. The financial transaction involves the first transaction participant and a second transaction participant.

Then, current location information of the second transaction participant is received, and the transaction is authorized in accordance with a correlation between the current location information and location information of the first transaction participant.

According to another aspect of the invention, there is provided a financial transaction authorization server which comprises a database of records of fixed-location transaction participants, and transaction authorization means in communication with the database of records. Each record of the database of records is associated with a respective one of the fixed-location transaction participants and identifies a physical location of the associated fixed-location transaction participant. The transaction authorization means is configured to (i) receive a request from one of the fixed-location transaction participants for completion of a financial transaction; (ii) receive current location information of a mobile-location transaction participant associated with the financial transaction; and (iii) authorize the transaction in accordance with a correlation between the received current location information and physical location of the fixed-location transaction participant.

In a preferred implementation, the mobile-location transaction participant is provided with a wireless authorization device, and the transaction authorization means is configured to receive the current location information from the wireless authorization device. Preferably, the wireless authorization device comprises a Global Positioning System (GPS) receiver, and a wireless transmitter coupled to the GPS receiver, and the transaction authorization means is configured to receive GPS co-ordinate information from the wireless transmitter.

In the preferred implementation, the transaction authorization means is configured to transmit a notification of the financial transaction to the wireless authorization device, to receive an authorization signal from the wireless authorization device together with the GPS co-ordinate information, and to authorize the transaction in accordance with the received authorization signal and the received GPS co-ordinate information. Preferably, the financial transaction comprises a debit card or a credit card transaction, and the financial transaction notification comprises a monetary amount of the transaction.

### BRIEF DESCRIPTION OF THE DRAWINGS

The invention will now be described, by way of example only, with reference to the accompanying drawings, in which:

FIG. 1 is a schematic diagram depicting a financial transaction authorization network, including the wireless authorization devices and the financial transaction authorization system;

FIG. 2 is a schematic diagram depicting certain functional details of the wireless authorization device; and

FIG. 3 is a data flow diagram depicting the method performed by the financial transaction authorization system when authorizing a financial transaction over the financial transaction authorization network.

### DETAILED DESCRIPTION OF THE PREFERRED EMBODIMENT

### 1.0. Structure of Financial Transaction Authorization Network 100

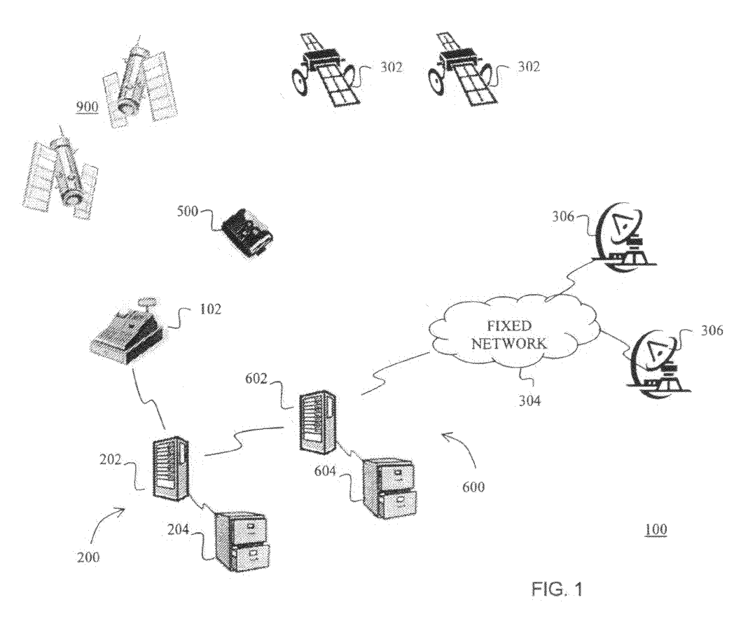

FIG. 1 is a schematic view of a financial transaction authorization network, denoted generally as 100. The financial transaction authorization network 100 is shown comprising a financial institution 200, a satellite communication network 300, a GPS location network 400, a wireless authorization device 500, and a financial transaction authorization system 600.

As shown, the financial transaction authorization network 100 also comprises a point of sale 102. Typically, a vendor (a “physical vendor”) wishing to sell goods or services from the vendor's physical premises has one or more point of sale (POS) terminals to facilitate the sale using credit cards, debit cards, or Smartcard devices. In this situation, the point of sale 102 would comprise the vendor's POS terminals. Alternately, however, a vendor (a “virtual vendor”) may wish to sell its goods or services, not from a physical premises, but from an Internet web site. In this latter situation, the point of sale 102 comprises the computer server from which the sale is initiated.

Although the financial transaction authorization network 100 is shown comprising only a single point of sale 102, a single financial institution 200, and a single wireless authorization device 500, typically the financial transaction authorization network 100 includes a plurality of points of sale 102, a plurality of financial institutions 200, and a plurality of wireless authorization devices 500. Further, although the financial transaction authorization server 600 is depicted as being distinct from the financial institution 200, the functionality of the financial transaction authorization server 600 may instead be implemented at the financial institutions 200.

### 1.1. Point of Sale 102

As discussed above, the point of sale 102 may comprises a physical POS terminal Preferably, the POS terminals used by each vendor are configured with a vendor identification number which is uniquely associated with each vendor.

Each POS terminal is of conventional design, and comprises a data processing subsystem, a display device, a keypad, and a cash drawer provided within a common housing. The data processing subsystem interfaces with the display device, the keypad and the cash drawer. The keypad is used to input particulars of a financial transaction into the data processing subsystem, such as a code associated with the good or service being purchased, and the transaction amount (e.g. price) of the good or service. The display device is used to display particulars of the financial transaction, such as the credit/debit card used in the transaction, the name of the good/service, and/or the associated transaction amount.

The data processing subsystem of the POS terminal also interfaces with a portable authorization terminal via a flexible cable. The portable authorization terminal comprises a data processor, a magnetic card reader, a display device, and a keypad provided in a common portable housing. The magnetic card reader is configured to read the magnetic stripe on a debit card and/or a credit card. The keypad is used to input an personal identification number (PIN) into the data processor for the purpose of initiating authorization of the transaction. The display device is used to display particulars of the financial transaction, such as the transaction amount.

As discussed above, instead of a POS terminal, the point of sale 102 may comprise a computer server from which sales are initiated. Where the computer server facilitates sales for a plurality of vendors, preferably the computer server is configured with a plurality of vendor identification numbers, each being uniquely associated with a specific vendor. Alternately, where the computer server is only used to facilitate sales for a single vendor, the vendor identification number may comprise the network address of the computer server.

### 1.2. Financial Institution 200

Each financial institution 200 is associated with a portion of the points of sale 102, and provides debit or a credit services via the associated point of sale 102. As shown in FIG. 1, each financial institution 200 is provided with a financial institution server 202 and with a subscriber database 204.

The financial institution server 202 is in communication with the associated point of sale 102 via a secure network communications link, and has access to the subscriber database 204. The subscriber database 204 comprises a plurality of subscriber records, each associated with a respective financial institution subscriber. Each financial institution subscriber is typically a financial transaction consumer.

Preferably, the subscriber record associated with each financial institution subscriber identifies the subscriber's credit card number and/or debit card number, the subscriber's PIN, and a subscriber identification number which is uniquely associated with the consumer.

### 1.3. Satellite Communication Network 300

As shown in FIG. 1, the satellite communication network 300 is in communication with the financial transaction authorization system 600, and comprises a bidirectional wireless communications network and a bidirectional wired communications network.

The bidirectional wireless communications network comprises a plurality of geo-synchronous or geo-stationary satellite stations 302 which orbit above the Earth. Each such satellite station 302 includes a satellite antenna, and a wireless transmitter and a wireless receiver disposed within a common housing. The wireless transmitter is coupled to the satellite antenna, and is configured to transmit wireless communication signals towards the surface of the Earth. The wireless receiver is also coupled to the satellite antenna, and is configured to receive wireless communication signals which emanate from the surface of the Earth.

The bidirectional wired communications network is in communication with the financial transaction authorization system 600 via a fixed network 304, and comprises a plurality of fixed-location terrestrial satellite stations 306 which track the satellite stations of the bidirectional wireless communications network. Each terrestrial satellite station 306 includes a terrestrial antenna, and a wireless transmitter and a wireless receiver disposed within a common housing. The wireless transmitter is coupled to the terrestrial antenna, and is configured to convert wired communication signals received from the financial transaction authorization system 600 into satellite communications signals, and to transmit the satellite communications signals (via the terrestrial antenna) to the satellite stations. The wireless receiver is also coupled to the terrestrial antenna, and is configured to convert satellite communication signals received from the satellite stations (via the terrestrial antenna) into wired communication signals, and to transmit the wired communication signals to the financial transaction authorization system 600.

### 1.4. GPS Location Network 400

The GPS location network 400 comprises a plurality of geo-synchronous medium Earth orbit satellites. As is well known by persons skilled in the art, a land-based GPS receiver uses satellite signals received from the GPS satellites to generate longitude/latitude location information representing the location of the GPS receiver.

### 1.5. Wireless Authorization Device 500

Each consumer who has subscribed to the authorization services of the financial transaction authorization network 100 is provided with a wireless authorization device 500. Each wireless authorization device 500 is a two-way wireless communications device, and is configured to operate within the satellite communication network 300 and the GPS location network 400. Further, each wireless authorization device 500 is configured with a terminal number which is uniquely associated with the wireless authorization device 500.

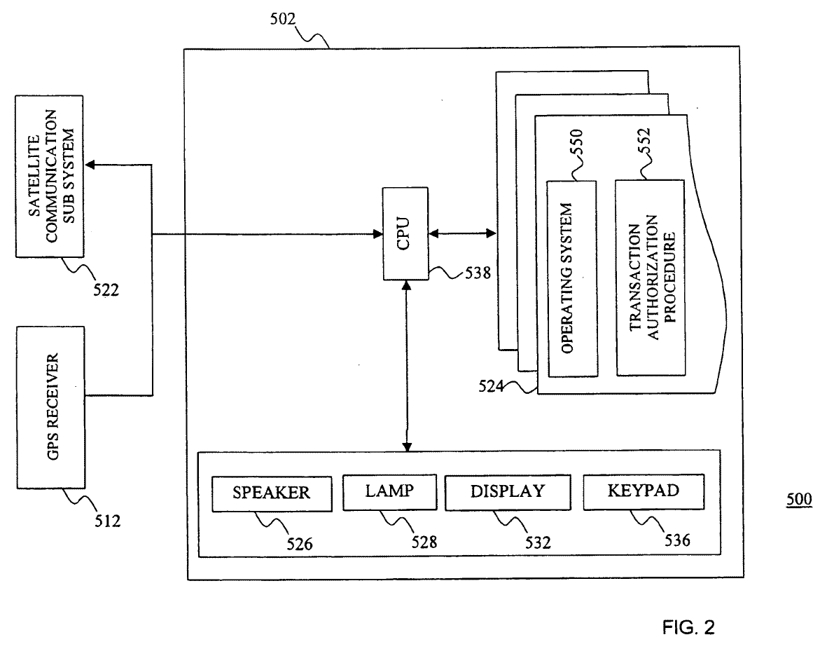

As shown in FIG. 2, the wireless authorization device 500 includes a GPS receiver 512, a satellite communication subsystem 522, and a data processing subsystem 502 in communication with the GPS receiver 512 and the satellite communication subsystem 522. Preferably, the GPS receiver 512, the satellite communication subsystem 522, and the data processing subsystem 502 are disposed within a common housing.

The GPS receiver 512 includes a mobile satellite antenna, and a signal processing subsystem coupled to the mobile satellite antenna. The signal processing subsystem converts satellite signals received from the GPS satellites of the GPS location network 400 (via the mobile satellite antenna) into longitude/latitude location information representing the location of the wireless authorization device 500.

The satellite communication subsystem 522 includes a portable satellite antenna, and a wireless receiver and a wireless transmitter coupled to the portable satellite antenna. The wireless receiver is configured to convert satellite communication signals received from the satellite communication network 300 (via the portable satellite antenna) into a form suitable for use by the data processing subsystem 502. The wireless transmitter is configured to convert information received from the data processing subsystem 502 into satellite communications signals suitable for use by the satellite communication network 300, and to transmit the satellite communications signals (via the portable satellite antenna) to the satellite communication network 300.

Although the wireless authorization device 500 is shown comprising both a mobile satellite antenna for receiving satellite signals from the GPS location network 400, and a portable satellite antenna for communicating with the satellite communication network 300, the mobile satellite antenna and the portable satellite antenna may be provided as a single common antenna.

As shown, the data processing subsystem 502 comprises flash memory 524, a speaker 526, a light emitting diode (LED) 528, a display 532, a keypad 536, and a microprocessor 538 in communication with the flash memory 524, the speaker 526, the LED 528, the display 532, and the keypad 536. Preferably, the keypad 536 includes a set of numerical and/or alphabetic keys, and a cancel key.

The flash memory 524 includes computer processing instructions which, when executed by the microprocessor 538, implement an operating system 550, and a transaction authorization procedure 552. Preferably, the flash memory 524 also saves a passkey sequence, and the unique terminal number that was assigned to the wireless authorization device 500. Further, preferably the flash memory 524 also includes an encryption key which is used to provide encrypted communications between the financial transaction authorization system 600 and the wireless authorization device 500.

The operating system 550 allows the data processing subsystem 502 to receive longitude/latitude location information from the GPS receiver 512, and to transmit information to and receive information from the satellite communication network 300 via the communication subsystem 511.

In particular, the operating system 550 is configured to receive over the satellite communication network 300 notification of an attempted financial transaction, and to transmit over the satellite communication network 300 longitude/latitude location information of the location of the wireless authorization device 500.

The transaction authorization procedure 552 is configured to receive the notification of an attempted financial transaction, to notify the bearer of the wireless authorization device 500 of the attempted financial transaction via the speaker 526 and/or the LED 528, and optionally to display the particulars of the financial transaction on the display 532, such as the debit/credit card used to initiate the transaction, the name of the good/service being purchased, and the transaction amount. The transaction authorization procedure 552 is also configured to initiate the transmission of location information over the satellite communication network 300, as will be described in further detail below.

### 1.6. Financial Transaction Authorization System 600

The financial transaction authorization system 600 is in communication with the financial institution server 202 of the financial institutions 200, and with the wired communication network of the satellite communication network 300.

As shown in FIG. 1, the financial transaction authorization system 600 comprises a financial transaction authorization server 602 and a subscriber database 604. The financial transaction authorization server 602 is in communication with the subscriber database 604. The subscriber database 604 comprises a plurality of authorization subscriber records, each associated with a respective subscriber of the authorization services of the financial transaction authorization network 100. Each authorization service subscriber may be a vendor or a consumer.

Where the authorization service subscriber is a vendor, the associated subscriber record indicates whether the vendor is a physical vendor or a virtual vendor, and includes fixed location information of the vendor's premises (if the service subscriber is a physical vendor), and the vendor identification number which was assigned to the vendor. Preferably, the vendor's location information is provided as a longitude-latitude co-ordinate pair.

Where the authorization service subscriber is a consumer, preferably the associated subscriber record includes a subscriber identification number (preferably the same number associated with the subscriber in the subscriber database 204 of the financial institution 200), and the unique terminal number of the wireless authorization device 500 that is assigned to the consumer. Preferably, the consumer's subscriber record also includes an encryption key which is used to provide encrypted communications between the financial transaction authorization system 600 and the wireless authorization device 500.

The financial transaction authorization server 602 is implemented as a computer server, and is configured to receive a notification from one of the financial institutions 200 indicating that a consumer of one of the associated vendors has attempted a financial transaction with the vendor, either by swiping a credit/debit card at a a point of sale terminal 102, or by inputting a credit card number via a computer terminal that is in communication with a point of sale computer server 102. The financial transaction authorization server 602 is also configured to transmit (via the satellite communication network 300) transaction notification information of the attempted transaction to the wireless authorization device 500 assigned to the consumer whose credit/debit card number was provided to the point of sale 102.

Also, the financial transaction authorization server 602 is configured to receive current GPS location information from the wireless authorization device 500 (via the satellite communication network 300) indicating the current location of the wireless authorization device 500 assigned to the consumer whose credit/debit card number was provided to the point of sale 102.

Further, the financial transaction authorization server 602 is configured generate an authorization message in accordance with a correlation between the received GPS location information and the fixed location information (if a physical vendor) of the vendor whose point of sale 102 was used to initiate the transaction. The financial transaction authorization server 602 is also configured to transmit the authorization message to the financial institution 200 for approval/refusal of the financial transaction and/or suspension of the financial account associated with the credit/debit card that was used to initiate the transaction.

### 2.0. Method of Operation of Financial Transaction Authorization Network 100

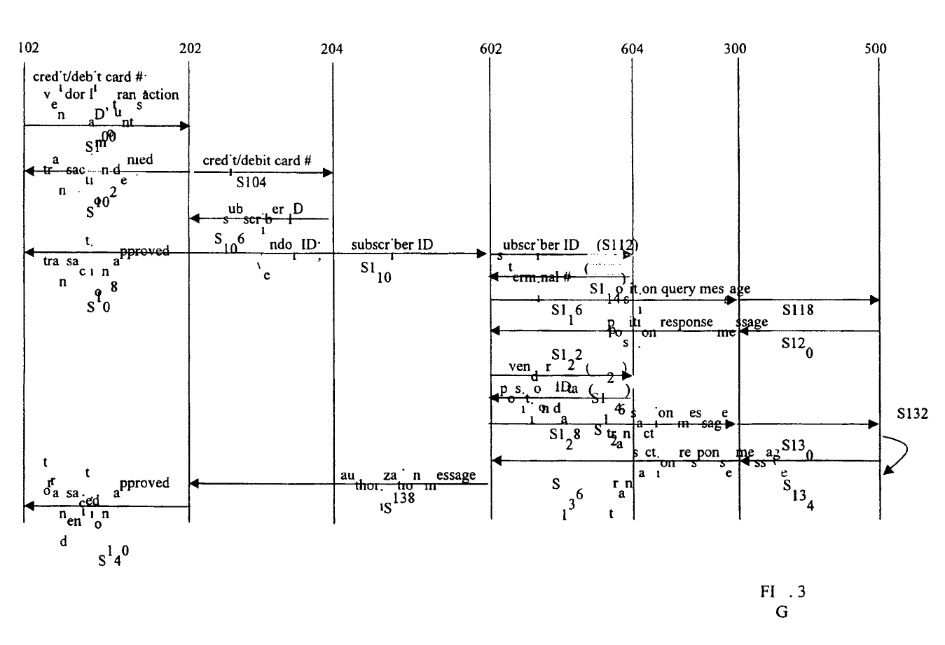

FIG. 3 depicts, in detail, the sequence of steps performed by the financial transaction authorization system 600 when authorizing a financial transaction over the financial transaction authorization network 100.

Initially, a consumer is provided with one of the wireless authorization devices 500. Preferably, the provider of the wireless authorization devices 500 (e.g. one of the financial institutions 200) registers the wireless authorization device 500 the financial transaction authorization network 100 by entering the terminal number of the wireless authorization device 500 into the financial transaction authorization system 600 via a website associated with the financial transaction authorization server 602, and then providing the financial transaction authorization system 600 with the subscriber identification number that is associated with the consumer in the financial institution's subscriber database 204.

Subsequently, a consumer enters the premises, or visits the web site, of one of the vendors who has subscribed to the authorization services of the financial transaction authorization network 100, and initiates a financial transaction with the vendor. The consumer attempts to complete the transaction by providing the vendor's point of sale 102 with a credit card or debit card number, either by swiping the card through the card reader of one of the vendor's portable authorization terminals, or by inputting a credit card number into a computer terminal that is in communication with the vendor's web site. If the consumer swiped a debit card, the consumer also inputs the consumer's PIN into the portable authorization terminal, via the keypad of the authorization terminal.

At step S100, the credit/debit card information (and PIN, if entered) is transmitted, together with the vendor identification number and the transaction amount, to the financial institution 200 that is associated with the point of sale 102.

The financial institution 200 determines whether the financial account associated with the received credit/debit card information has sufficient credit/funds for completion of the transaction. Further, if the consumer used a debit card, the financial institution 200 determines whether the PIN received from the consumer matches the PIN on with the file financial institution 200 for the received debit card number. If not, the financial institution 200 responds to the point of sale 102 with a message, at step S102, indicating that the requested financial transaction with the vendor has been denied.

However, if the financial institution 200 determines that the financial account associated with the received credit/debit card information has sufficient credit/funds for completion of the transaction, at step S104 the financial institution server 202 of the financial institution 200 queries the subscriber database 204 with the received credit/debit card information, and receives the subscriber identification number (if any) associated with the credit/debit card information, at step S106. If the financial institution server 202 is unable to locate any record in the subscriber database 204 associated with the received credit/debit card information, or if the financial institution 200 determines that the transaction is a pre-authorized transaction, at step S108 the financial institution 200 approves the transaction and responds to the point of sale 102 with a message indicating that the requested financial transaction with the vendor has been approved.

However, if the financial institution server 202 locates a record in the subscriber database 204 associated with the received credit/debit card information, at step S110 the financial institution server 202 transmits the located subscriber identification number to the financial transaction authorization system 600, together with the vendor identification number, and optionally a portion of the credit/debit card number (e.g. card type followed by last 4 digits) that was used to initiate the transaction and/or the transaction amount.

At step S112, the financial transaction authorization server 602 queries the subscriber database 604 with the received subscriber identification number, and receives the terminal number of the wireless authorization device 500 that is associated with the subscriber identification number, at step S114. If the received vendor identification number is associated with a virtual vendor, processing skips to step 128.

However, if the received vendor identification number is associated with a physical vendor, the financial transaction authorization server 602 generates a position query message which requests current location information from the wireless authorization device 500 having the specified terminal number. The financial transaction authorization server 602 also generates a unique temporary random transaction identifier, and includes the transaction identifier with the position query message. Preferably, the financial transaction authorization server 602 encrypts the position query message with the encryption key that is associated with the subscriber identification number in the subscriber database 604. Then, at step S116, the financial transaction authorization server 602 transmits the position query message to the satellite communication network 300 which, in turn, forwards the position query message to the wireless authorization device 500, at step S118.

Upon receipt of the transaction message at the wireless authorization device 500, the operating system 550 decrypts the transaction message with its decryption key (if required). If the terminal number specified in the message matches the terminal number of the wireless authorization device 500, the transaction authorization procedure 552 causes the operating system 550 to retrieve the longitude/latitude co-ordinates of the wireless authorization device 500 from the GPS receiver 512. The transaction authorization procedure 552 then generates a position response message which includes the longitude/latitude co-ordinates and the transaction identifier. The transaction authorization procedure 552 encrypts the position response message with the encryption key (if required), and then causes the operating system 550 to transmit the position response message to the satellite communication network 300, at step S120, which, in turn, forwards the position response message to the financial transaction authorization server 602, at step S124. Preferably, the position response message includes the terminal number of the wireless authorization device 500 to allow the financial transaction authorization server 602 to select the appropriate decryption key and to decrypt the position response message (if required).

Upon receipt of the position response message, the financial transaction authorization server 602 uses the transaction identifier included with the location response message to determine the vendor identification number of the vendor that is associated with the transaction. The financial transaction authorization server 602 then queries the subscriber database 604 with the vendor identification number, at step S124, and receives, in response the longitude-latitude co-ordinates of the vendor, at step S126.

The financial transaction authorization server 602 then compares the longitude-latitude co-ordinates of the vendor with the longitude/latitude co-ordinates of the wireless authorization device 500. If the two sets of co-ordinates do not match within a predetermined tolerance level, processing proceeds to step S138.

However, if the two sets of co-ordinates do match within a predetermined tolerance level, or if the financial transaction authorization server 602 determined at step S116 that the vendor was a virtual vendor, the financial transaction authorization server 602 generates a transaction message which indicates that a financial transaction with one of the consumer's credit/debit cards has been initiated. The transaction message includes the transaction identifier, and optionally includes the portion of the credit/debit card number that was used to initiate the transaction and/or the transaction amount of the financial transaction.

Preferably, the financial transaction authorization server 602 encrypts the transaction message with the encryption key that is associated with the subscriber identification number in the subscriber database 604. Then, at step S128, the financial transaction authorization server 602 transmits the transaction message to the satellite communication network 300 which, in turn, forwards the transaction message to the wireless authorization device 500, at step S130.

Upon receipt of the transaction message at the wireless authorization device 500, the operating system 550 decrypts the transaction message with its decryption key (if required). If the terminal number specified in the message matches the terminal number of the wireless authorization device 500, the transaction authorization procedure 552 notifies the bearer of the wireless authorization device 500 of the attempted financial transaction by generating a tone via the speaker 526 and/or by flashing or otherwise activating the LED 528. Further, if the transaction message includes the portion of the credit/debit card number that was used to initiate the transaction and/or transaction amount, the transaction authorization procedure 552 also displays this information on the display 532.

If the bearer of the wireless authorization device 500 did not initiate the financial transaction, or did not initiate the financial transaction for the displayed transaction amount, the can bearer simply ignore the transaction message to thereby terminate the transaction.

Alternately, if the bearer realizes that his/her credit/debit card has been stolen, at step S132 the bearer can activate the cancel key on the keypad 536 of the terminal 500 to thereby temporarily suspend the account at the financial institution 200 that issued the card. In response to the activation of the cancel key, the transaction authorization procedure 552 generates a transaction response message which includes the transaction identifier, and indicates that the bearer of the terminal 500 has requested temporary suspension of the credit/debit card. Once suspended, the bearer can reactivate the card again by making a telephone call to the financial institution 200, and providing suitable identity verification information.

However, if the bearer of the wireless authorization device 500 initiated the financial transaction, at step S132 the bearer inputs a key sequence into the portable authorization terminal 500 via the numerical and/or alphabetic keys of the keypad 536. The transaction authorization procedure 552 then determines whether the key sequence input matches the passkey sequence that is saved in the flash memory 524. If so, the transaction authorization procedure 552 generates a transaction response message which includes the transaction identifier, and indicates that the bearer of the terminal 500 has authorized the transaction. On the other hand, if the key sequence input via the keypad 526 at step S132 does not match the passkey sequence that is saved in the flash memory 524, the transaction authorization procedure 552 does not respond to the transaction message.

At step S134, the transaction authorization procedure 552 encrypts the transaction response message (if any) with the encryption key (if required), and then causes the operating system 550 to transmit the transaction response message to the satellite communication network 300 which, in turn, forwards the response message to the financial transaction authorization server 602, at step S136. Preferably, the operating system 550 also transmits the terminal number of the wireless authorization device 500, along with the encrypted transaction response message, to allow the financial transaction authorization server 602 to select the appropriate decryption key and to decrypt the response message (if required).

If the transaction response message (if any) indicates that the bearer authorized the transaction, the financial transaction authorization server 602 generates a transaction authorization message which indicates that the financial institution 200 can proceed with the transaction.

On the other hand, if the financial transaction authorization server 602 does not receive a response from the wireless authorization device 500 within a predetermined period of time, or if the financial transaction authorization server 602 determined at step S126 that the co-ordinates of the vendor did not match the co-ordinates of the wireless authorization device 500, preferably the financial transaction authorization server 602 generates an authorization message which indicates that the financial institution 200 should not proceed with the transaction. Alternately, since the financial transaction authorization server 602 may not receive a response from the wireless authorization device 500 simply due to poor satellite reception, the financial transaction authorization system 600 may initiate a telephone call to a wireless telephone associated with the bearer of the wireless authorization device 500 to avoid unnecessary cancellation of the transaction in these situations. In this latter situation, the authorization message would only indicate that the financial institution 200 should not proceed with the transaction if the bearer could not confirm his/her identity to the financial transaction authorization system 600.

If the transaction response message indicates that the bearer requested temporary cancellation of the credit/debit card, the authorization message indicates that the financial institution 200 should temporarily suspend the account associated with the credit/debit card. In any of the preceding situations where a response message is generated, preferably the authorization message includes the subscriber identification number and the vendor identification number to allow the financial institution server 202 to identify the transaction.

At step S138, the financial transaction authorization server 602 transmits the authorization message to the financial institution server 202. If the transaction message indicates that the financial institution 200 can proceed with the transaction, the financial institution 200 authorizes the transaction, and issues a corresponding notification to the point of sale 102, at step S140.

However, if the transaction message indicates that the financial institution 200 should not proceed with the transaction, preferably the financial institution 200 suspends the account at the financial institution 200 that is associated with the swiped credit/debit card until the consumer provides the financial institution 200 with instructions (after identity verification) to re-activate the account. Alternately, the financial institution 200 may simply deny the current transaction, without suspending the account at the financial institution.

Alternately, the financial institution server 202 may defer verifying the availability of sufficient credit/funds (and/or the authenticity of PIN input) until after receipt of the authorization message at step S138.

1. A method of limiting the likelihood of a fraudulent financial transaction, comprising the steps of:
receiving a request from a first transaction participant for completion of a financial transaction, the financial transaction involving the first transaction participant and a second transaction participant;
receiving current location information of the second transaction participant; and
authorizing the transaction in accordance with a correlation between the current location information and location information of the first transaction participant.

2. The method according to claim 1, wherein the second transaction participant is provided with a wireless authorization device, and the current location receiving step comprises receiving the current location information from the wireless authorization device.

3. The method according to claim 2, wherein the wireless authorization device comprises a Global Positioning System (GPS) receiver, and a wireless transmitter coupled to the GPS receiver, and the current location receiving step comprises receiving GPS co-ordinate information from the wireless transmitter.

4. The method according to claim 3, wherein the current location receiving step comprises the steps of transmitting a notification of the financial transaction to the wireless authorization device, and receiving an authorization signal from the wireless authorization device together with the GPS co-ordinate information, and the transaction authorization step comprises authorizing the transaction in accordance with the received authorization signal and the received GPS co-ordinate information.

5. The method according to claim 4, wherein the financial transaction comprises one of a debit card and a credit card transaction, and the financial transaction notification comprises a monetary amount of the transaction.

6. A financial transaction authorization server, comprising:
a database of records of fixed-location transaction participants, each said record being associated with a respective one of the fixed-location transaction participants and identifying a physical location of the associated fixed-location transaction participant; and
transaction authorization means in communication with the database of records, the transaction authorization means being configured to:
receive a request from one of the fixed-location transaction participants for completion of a financial transaction;
receive current location information of a mobile-location transaction participant associated with the financial transaction; and
authorize the transaction in accordance with a correlation between the received current location information and physical location of the fixed-location transaction participant.

7. The financial transaction authorization server according to claim 6, wherein the mobile-location transaction participant is provided with a wireless authorization device, and the transaction authorization means is configured to receive the current location information from the wireless authorization device.

8. The financial transaction authorization server according to claim 7, wherein the wireless authorization device comprises a Global Positioning System (GPS) receiver, and a wireless transmitter coupled to the GPS receiver, and the transaction authorization means is configured to receive GPS co-ordinate information from the wireless transmitter.

9. The financial transaction authorization server according to claim 8, wherein the transaction authorization means is configured to transmit a notification of the financial transaction to the wireless authorization device, to receive an authorization signal from the wireless authorization device together with the GPS co-ordinate information, and to authorize the transaction in accordance with the received authorization signal and the received GPS co-ordinate information.

10. The financial transaction authorization server according to claim 9, wherein the financial transaction comprises one of a debit card and a credit card transaction, and the financial transaction notification comprises a monetary amount of the transaction.
